(19) United States
(12) Patent Application Publication
(10) Pub. No.: US 2025/0102976 A1
(43) Pub. Date: Mar. 27, 2025

(54) FIXING DEVICE AND IMAGE FORMING APPARATUS

(71) Applicant: FUJIFILM Business Innovation Corp., Tokyo (JP)

(72) Inventors: Keita HASHIMOTO, Kanagawa (JP); Akira SHIMODAIRA, Kanagawa (JP)

(73) Assignee: FUJIFILM Business Innovation Corp., Tokyo (JP)

(21) Appl. No.: 18/432,915

(22) Filed: Feb. 5, 2024

(30) Foreign Application Priority Data
Sep. 22, 2023 (JP) 2023-156649

(51) Int. Cl. G03G 15/20; G03G 15/00

(52) U.S. Cl. CPC G03G 15/2035; G03G 15/2028; G03G 15/205; G03G 15/2064; G03G 15/70

(57) ABSTRACT

A fixing device includes a heating rotary body, a pressing unit that presses a recording medium against the heating rotary body at a fixation region, a backward rotation unit that rotates the heating rotary body in a direction opposite to a direction of rotation at a time of fixation in a case where the recording medium is wound around the heating rotary body, and a peeling unit that is brought relatively close to an outer peripheral surface of the heating rotary body at a position upstream of the fixation region in a transport direction of the recording medium and that peels off the recording medium wound around the heating rotary body at a time of backward rotation of the heating rotary body.

### CROSS-REFERENCE TO RELATED APPLICATIONS

This application is based on and claims priority under 35 USC 119 from Japanese Patent Application No. 2023-156649 filed Sep. 22, 2023.

### BACKGROUND

### (i) Technical Field

The present invention relates to a fixing device and an image forming apparatus.

### (ii) Related Art

In the related art, as techniques related to a fixing device, for example, techniques disclosed in JP2014-174542A, JP2005-309022A, or the like have already been proposed.

Disclosed in JP2014-174542A is a fixing device including a drive source that causes a fixing member to rotate forward and backward and a separation unit that prevents a recording medium from being entangled in a case where the fixing member rotates backward in a state where the recording medium is at a fixing nip portion, the fixing device being configured such that an adjustment mechanism adjusting the value of a gap between the fixing member and the separation unit.

Disclosed in JP2005-309022A is a configuration in which, in a case where a sheet wound around a first roller is to be separated, a peeling unit abuts the first roller and a rotation unit causes the first roller to rotate in a backward rotation direction so that the sheet wound around the first roller is made stranded on the peeling unit and the sheet is peeled off the first roller to be separated from the first roller. The peeling unit is disposed downstream of the fixing nip portion.

### SUMMARY

Aspects of non-limiting embodiments of the present disclosure relate to a fixing device and an image forming apparatus with which it is possible to reliably remove a recording medium wound around an outer peripheral surface of a heating rotary body in comparison with a case where a peeling unit that peels off the recording medium wound around the outer peripheral surface of the heating rotary body when the heating rotary body rotates backward is provided downstream of a fixation region in a transport direction of the recording medium.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a fixing device including a heating rotary body, a pressing unit that presses a recording medium against the heating rotary body at a fixation region, a backward rotation unit that rotates the heating rotary body in a direction opposite to a direction of rotation at a time of fixation in a case where the recording medium is wound around the heating rotary body, and a peeling unit that is brought relatively close to an outer peripheral surface of the heating rotary body at a position upstream of the fixation region in a transport direction of the recording medium and that peels off the recording medium wound around the heating rotary body at a time of backward rotation of the heating rotary body.

### BRIEF DESCRIPTION OF THE DRAWINGS

Exemplary embodiment(s) of the present invention will be described in detail based on the following figures, wherein:

FIG. 1 is an overall configuration diagram showing an image forming apparatus to which a fixing device according to Exemplary Embodiment 1 of the present invention is applied;

FIG. 2 is a configuration diagram showing an image forming unit of the image forming apparatus to which the fixing device according to Exemplary Embodiment 1 of the present invention is applied;

FIG. 3 is a configuration diagram showing a major part of the image forming apparatus;

FIG. 4 is a configuration diagram showing a state where a rear cover of the image forming apparatus is open;

FIG. 5 is a configuration diagram showing the fixing device according to Exemplary Embodiment 1 of the present invention;

FIG. 6 is a cross-sectional configuration diagram showing a heating roll and a pressing roll

FIG. 7 is a side configuration diagram showing the fixing device according to Exemplary Embodiment 1 of the present invention;

FIG. 8 is a configuration diagram showing a nip-released state of the fixing device according to Exemplary Embodiment 1 of the present invention;

FIG. 9 is a schematic diagram showing a recording sheet wound around a surface of a heating roll;

FIGS. 10A and 10B are schematic configuration diagrams showing a fixing device in which a recording sheet is wound around a surface of a heating roll;

FIG. 11 is a schematic diagram showing a recording sheet completely wound around a surface of the heating roll;

FIG. 12 is a flowchart showing an operation of the fixing device according to Exemplary Embodiment 1 of the present invention;

FIG. 13 is a configuration diagram showing the nip-released state of the fixing device according to Exemplary Embodiment 1 of the present invention;

FIG. 14 is a configuration diagram showing a fixing device according to Exemplary Embodiment 2 of the present invention;

FIGS. 15A and 15B are schematic diagrams showing an operation of the fixing device according to Exemplary Embodiment 2 of the present invention;

FIG. 16 is a flowchart showing the operation of the fixing device according to Exemplary Embodiment 2 of the present invention;

FIG. 17 is a configuration diagram showing the operation of the fixing device according to Exemplary Embodiment 2 of the present invention; and

FIG. 18 is a schematic configuration diagram showing the operation of a fixing device in the related art.

### DETAILED DESCRIPTION

Hereinafter, modes for carrying out the invention (hereinafter, referred to as an “exemplary embodiment”) will be described with reference to the drawings.

### Exemplary Embodiment 1

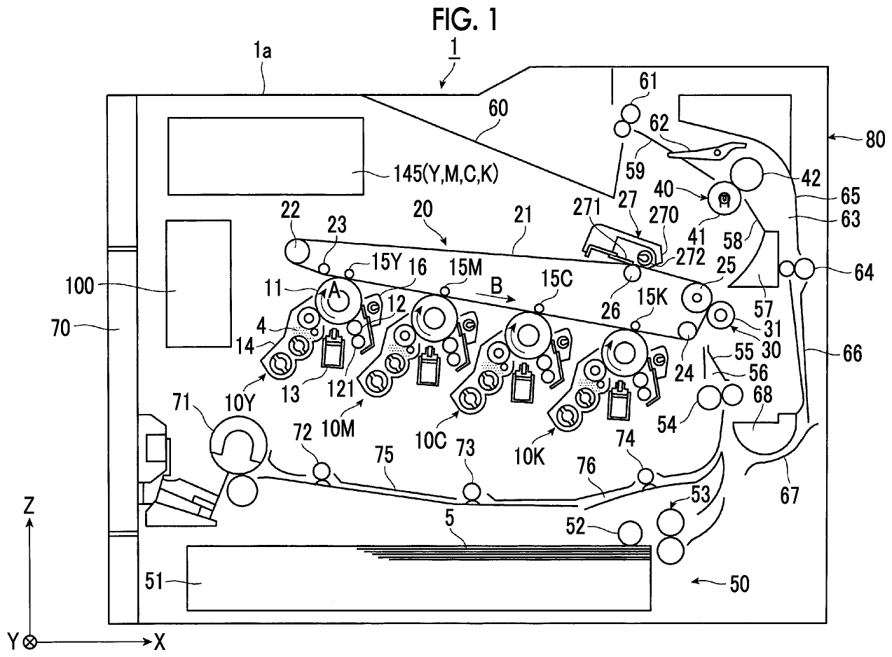

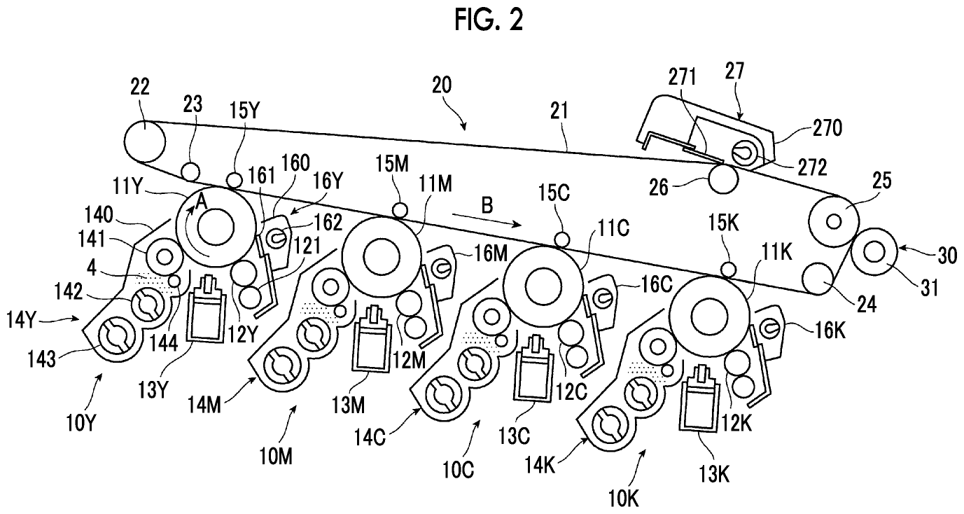

FIG. 1 shows an overall outline of an image forming apparatus to which a fixing device according to Exemplary Embodiment 1 is applied and FIG. 2 is an enlarged diagram showing an image forming unit of the image forming apparatus. In FIG. 1, a reference numeral “X” indicates a horizontal direction (a width direction) of the image forming apparatus, a reference numeral “Y” indicates a depth direction of the image forming apparatus, and a reference numeral “Z” indicates a vertical direction of the image forming apparatus.

### Overall Configuration of Image Forming Apparatus

An image forming apparatus 1 is configured as, for example, a color printer. As shown in FIG. 1, the image forming apparatus 1 includes a plurality of image creating devices 10, an intermediate transfer device 20, a paper feeding device 50, and a fixing device 40 which is an example of a fixing section according to Exemplary Embodiment 1. The plurality of image creating devices 10 form toner images which are developed by toner constituting a developer. The intermediate transfer device 20 holds the toner images respectively formed by the image creating devices 10 and transports the toner images to a secondary transfer position where the toner images are secondarily transferred to a recording sheet 5, which is an example of a recording medium, in the end. The paper feeding device 50 accommodates and transports the required recording sheet 5 to be supplied to the secondary transfer position of the intermediate transfer device 20. The fixing device 40 fixes the toner images, each of which is an example of an image, on the recording sheet 5 that has been subjected to secondary transfer at the intermediate transfer device 20. In FIG. 1, a reference numeral “1a” indicates an apparatus body formed by a supporting structural member, an exterior cover, or the like.

In Exemplary Embodiment 1, the plurality of image creating devices 10 and the intermediate transfer device 20 constitute an image forming section that forms a toner image on a recording medium. Note that the image forming section may be configured to include a single image creating device and to directly form a toner image on a recording medium by using the image creating device without an intermediate transfer device.

The image creating devices 10 include four image creating devices 10Y, 10M, 10C, and 10K that exclusively form toner images in four colors of yellow (Y), magenta (M), cyan (C), and black (K), respectively. In an internal space of an apparatus body 1a, the four image creating devices 10 (Y, M, C, K) are disposed in a row along a horizontal direction X in a state of being inclined.

As shown in FIG. 1, each of the image creating devices 10 (Y, M, C, K) includes a photoconductor drum 11 which is an example of a rotating image holding unit. Mainly, devices as follows are disposed in the vicinity of the photoconductor drum 11. The main devices are a charging device 12, an exposure device 13, a development device 14, a primary transfer device 15, a drum cleaning device 16, and the like. The charging device 12 charges a peripheral surface (an image holding surface) of the photoconductor drum 11, on which an image can be formed, to a required potential. The exposure device 13 irradiates the charged peripheral surface of the photoconductor drum 11 with light based on image information (a signal) to form an electrostatic latent image with a potential difference (for each color). The development device 14 develops the electrostatic latent image with toner of a developer of a corresponding color (Y, M, C, K) to obtain a toner image. The primary transfer device 15 transfers each toner image to the intermediate transfer device 20. The drum cleaning device 16 cleans the photoconductor drum 11 by removing adhering substances such as toner that remain on and adhere to the image holding surface of the photoconductor drum 11 after the primary transfer. Note that reference numerals indicating the photoconductor drum 11, the charging device 12, and the like are given only to an image creating device 10Y of yellow (Y), and are omitted for the other image creating devices 10 (M, C, K).

The photoconductor drum 11 is obtained by forming, on a peripheral surface of a cylindrical or columnar base material to be grounded, an image holding surface including a photoconductive layer (a photosensitive layer) made of a photosensitive material. The photoconductor drum 11 is supported to rotate in a direction indicated by an arrow A as drive power is transmitted from a drive device (not shown).

The charging device 12 is composed of a contact type charging roll that is disposed in a state of being in contact with the photoconductor drum 11. A charging voltage is supplied to the charging device 12. As the charging voltage, a voltage or a current having the same polarity as the charging polarity of a toner supplied from the development device 14 is supplied in a case where the development device 14 performs reversal development. On a rear surface side of the charging device 12, a cleaning roll 121 that cleans a surface of the charging device 12 is disposed in a state of being in contact with the charging device 12.

The exposure device 13 consists of an LED print head or the like that forms an electrostatic latent image by irradiating the photoconductor drum 11 with light according to image information by means of a light emitting diode (LED), which is a plurality of light emitting elements arranged along an axial direction of the photoconductor drum 11. When a latent image is to be formed, information (a signal) of an image which is input into the image forming apparatus 1 by any means is transmitted to the exposure device 13. Note that, as the exposure device 13, a device that forms an electrostatic latent image by irradiating the peripheral surface of the charged photoconductor drum 11 with laser light organized according to image information input into the image forming apparatus 1 may also be used.

As shown in FIG. 2, each development device 14 is configured by disposing a development roll 141, agitating and transporting members 142 and 143, a layer thickness restriction member 144, and the like in a housing 140 in which an opening portion and a developer accommodation chamber are formed. The development roll 141 holds a developer 4 and transports the developer 4 to a development region that faces the photoconductor drum 11. The agitating and transporting members 142 and 143 consist of screw augers or the like that transport the developer 4 to cause the developer 4 to pass through the development roll 141 while agitating the developer 4. The layer thickness restriction member 144 restricts the amount (a layer thickness) of the developer 4 held on the development roll 141. Regarding the development device 14, a developing voltage from a power supply device (not shown) is supplied to a space between the development roll 141 and the photoconductor drum 11. Additionally, the development roll 141 and the agitating and transporting members 142 and 143 rotate in a required direction with drive power transmitted thereto from a drive device (not shown). Furthermore, as the four-color developers 4, two-component developers containing a non-magnetic toner and a magnetic carrier are used.

As shown in FIG. 1, the primary transfer device 15 is a contact type transfer device including a primary transfer roll that rotates at a primary transfer position in a state of being in contact with the peripheral surface of the photoconductor drum 11 with an intermediate transfer belt 21 interposed therebetween and to which a primary transfer voltage is supplied. As the primary transfer voltage, a direct-current voltage having a polarity opposite to the charging polarity of the toner is supplied from the power supply device (not shown).

As shown in FIG. 2, the drum cleaning device 16 is composed of a cleaning blade 161, a sending member 162, and the like disposed inside a container-shaped body 160. The cleaning blade 161 performs cleaning by removing an adhering substance such as residual toner. The sending member 162 consists of a screw auger or the like that collects an adhering substance such as toner removed by the cleaning blade 161 and that transports the adhering substance to be sent to a collection system (not shown).

The intermediate transfer device 20 is disposed to be present at a position above each image creating device 10 (Y, M, C, K) in a vertical direction Z. The intermediate transfer device 20 is mainly composed of the intermediate transfer belt 21, a plurality of belt supporting rolls 22 to 26, a belt cleaning device 27, and a secondary transfer device 30. The intermediate transfer belt 21 is an example of an intermediate transfer unit that circulates and moves in a direction along an arrow B while passing through primary transfer positions between the photoconductor drums 11 and the primary transfer devices 15 (primary transfer rolls). The plurality of belt supporting rolls 22 to 26 hold, at an inner periphery of the intermediate transfer belt 21, the intermediate transfer belt 21 to be in a favorable state and support the intermediate transfer belt 21 to be circulatable and movable. The secondary transfer device 30 is disposed on an outer peripheral surface (an image holding surface) side of the intermediate transfer belt 21 supported by the belt supporting roll 25 and secondarily transfers a toner image on the intermediate transfer belt 21 to the recording sheet 5. The belt cleaning device 27 performs cleaning by removing adhering substances such as residual toner, paper dust, or the like adhering to the outer peripheral surface of the intermediate transfer belt 21 after passing through the secondary transfer device 30.

As the intermediate transfer belt 21, for example, an endless belt made of a material in which a resistance modifier such as carbon black is dispersed in a synthetic resin such as a polyimide resin, a polyamide resin, or a polyamideimide resin is used. In addition, the belt supporting roll 22 is configured as a drive roll. The belt supporting roll 23 is configured as a leveling roll that holds the traveling position of the intermediate transfer belt 21. The belt supporting roll 24 is configured as a tension applying roll that applies tension to the intermediate transfer belt 21. The belt supporting roll 25 is configured as a backup roll for secondary transfer. The belt supporting roll 26 is configured as a rear surface supporting roll of the belt cleaning device 27.

The secondary transfer device 30 includes a secondary transfer roll 31 that rotates at the secondary transfer position. The secondary transfer position is a portion of the outer peripheral surface of the intermediate transfer belt 21 that is supported by the belt supporting roll 25 of the intermediate transfer device 20. To the secondary transfer roll 31 or the belt supporting roll 25 of the intermediate transfer device 20, a direct current voltage having a polarity opposite to or the same as the charging polarity of a toner is supplied as the secondary transfer voltage.

The fixing device 40 is configured to include a heating roll 41 which is an example of a heating rotary body and a pressing roll 42 which is an example of a pressing unit. The heating roll 41 is heated by a heating unit such that the surface temperature of the heating roll 41 is maintained at a predetermined temperature. The pressing roll 42 comes into contact with the heating roll 41 at a required pressure and rotates. In this fixing device 40, a contact portion where the heating roll 41 and the pressing roll 42 come into contact with each other serves as a fixation nip portion N which is an example of a fixation region where a required fixation process (heating and pressing) of fixing an unfixed toner image onto the recording sheet 5 is performed. Note that the fixing device 40 will be described in detail below.

The paper feeding device 50 is disposed to be present at a position below the image creating devices 10 (Y, M, C, K). The paper feeding device 50 is mainly composed of a single or a plurality of sheet accommodating bodies 51 and sending devices 52 and 53 that send out the recording sheet 5 one by one from the sheet accommodating body 51. The sheet accommodating body 51 accommodates the recording sheet 5 of a favorable size, type, and the like in a state of being loaded on a loading plate (not shown). In addition, the sheet accommodating body 51 is attached, for example, such that the sheet accommodating body 51 can be pulled out to a front surface (a side surface that a user faces during operation) side of the apparatus body 1a (to a left surface side in an example shown in the drawing).

Examples of the recording sheet 5 include thin paper such as plain paper and tracing paper, OHP sheets consisting of transparent film-shaped mediums formed of a synthetic resin (PET or the like), or the like which are used in electrophotographic copying machines and printers. From the viewpoint of further improving the flatness of an image surface after fixation, it is preferable that the surface of the recording sheet 5 is as flat as possible, for example. As the recording sheet 5, for example, coated paper obtained by coating a surface of plain paper with a resin or the like, so-called thick paper having a relatively large basis weight like art paper for printing, or the like is also used.

A paper feed transport path 56 is provided between the paper feeding device 50 and the secondary transfer device 30. The paper feed transport path 56 is composed of a single or a plurality of sheet transporting roll pairs 54, which transport the recording sheet 5 fed from the paper feeding device 50 to the secondary transfer position, and a transport guide member 55. The sheet transporting roll pair 54 disposed at a position immediately before the secondary transfer position in the paper feed transport path 56 is configured as, for example, a roll (registration roll) that adjusts the transport timing of the recording sheet 5.

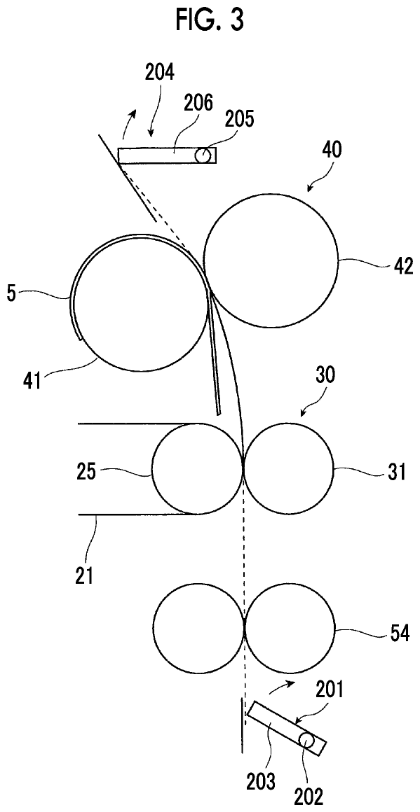

As shown in FIG. 3, a registration sensor 201 which is an example of a first detection unit detecting a leading end of the recording sheet 5 fed from the paper feeding device 50 is disposed upstream of the sheet transporting roll pairs 54 in a transport direction of the recording sheet 5. The registration sensor 201 includes an actuator 203 that rotates about a rotation fulcrum 202. In a case where the leading end of the recording sheet 5 passes through the registration sensor 201, the actuator 203 rotates about the rotation fulcrum 202, and the rotation of the actuator 203 is detected by an optical sensor (not shown) as passage of the leading end of the recording sheet 5.

In addition, as shown in FIG. 1, transport guide members 57 and 58 and the like that guide, to the fixing device 40, the recording sheet 5 sent from the secondary transfer device 30 are disposed between the secondary transfer device 30 and the fixing device 40.

A sheet discharging roll pair 61 that discharges the recording sheet 5, onto which a toner image has been fixed by the fixing device 40, to a sheet discharge portion 60 disposed at an upper portion of the apparatus body 1a and a transport guide member 59 and the like are provided downstream of the fixing device 40.

As shown in FIG. 3, at an exit portion of the fixing device 40, an exit sensor 204, which is an example of a second detection unit detecting the leading end of the recording sheet 5 subjected to the fixation process, is disposed. As with the registration sensor 201, the exit sensor 204 includes an actuator 206 that rotates about a rotation fulcrum 205. In a case where the leading end of the recording sheet 5 passes through the exit sensor 204, the actuator 206 rotates about the rotation fulcrum 205, and the rotation of the actuator 206 is detected by an optical sensor (not shown) as passage of the leading end of the recording sheet 5.

As shown in FIG. 1, a switching gate 62 that switches a sheet transport path is provided between the fixing device 40 and the sheet discharging roll pair 61. The sheet discharging roll pair 61 can switch a rotation direction thereof between a forward rotation direction (a discharge direction) and a backward rotation direction. In a case where images are to be formed on both sides of the recording sheet 5, the rotation direction of the sheet discharging roll pair 61 is switched from the forward rotation direction (the discharge direction) to the backward rotation direction after a trailing end of the recording sheet 5 having an image formed on one surface thereof passes through the switching gate 62. The transport path of the recording sheet 5 transported in the backward rotation direction by the sheet discharging roll pair 61 is switched by the switching gate 62 such that the recording sheet 5 is transported to a double-sided transport path 63 formed along a substantially vertical direction. The double-sided transport path 63 includes a sheet transporting roll pair 64 that transports the recording sheet 5 to the sheet transporting roll pair 54 in a state where the recording sheet 5 is inverted upside down, transport guides 65 to 68, and the like.

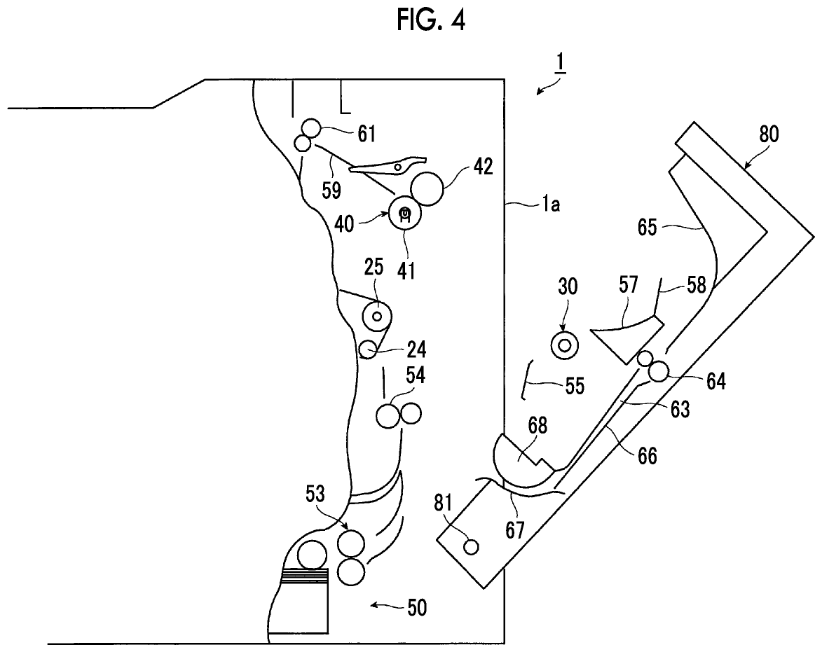

In addition, as shown in FIG. 4, the image forming apparatus 1 according to Exemplary Embodiment 1 is configured such that a rear cover 80, which is provided on a rear surface side of the apparatus body 1a and is an example of opening and closing means, can be opened and closed about a rotation fulcrum 81. By opening and closing the rear cover 80, it is possible to easily remove the recording sheet 5 of which a transport failure (jammed) has occurred. Examples of a place where the transport failure of the recording sheet 5 occurs include the paper feed transport path 56, a sheet discharge transport path composed of the sheet discharging roll pair 61, the transport guide member 59, and the like, the double-sided transport path 63, and the fixing device 40.

In FIG. 1, a reference numeral “70” indicates a manual feeding tray that is provided to be openable and closable at a front surface (a left surface in the drawing) of the apparatus body 1a of the image forming apparatus 1. Between the manual feeding tray 70 and the sheet transporting roll pair 54, a sending device 71 that sends out the recording sheet 5 accommodated in the manual feeding tray 70 one by one and a manual feeding transport path 76 composed of a plurality of sheet transporting roll pairs 72 to 74, a transport guide 75, and the like are provided.

In addition, a reference numeral “145 (Y, M, C, K)” in FIG. 1 indicates each of a plurality of toner cartridges that are arranged along a direction orthogonal to the page and that serve as developer accommodating containers each accommodating a developer containing at least a toner to be supplied to the corresponding development device 14 (Y, M, C, K).

In addition, a reference numeral “100” in FIG. 1 indicates a control device which is an example of a control unit that comprehensively controls the operation of the image forming apparatus 1. The control device 100 is configured to include a central processing unit (CPU), a read only memory (ROM), a random access memory (RAM) (not shown), a bus for connection between the CPU, the ROM, and the like, a communication interface, and the like.

### Basic Operation of Image Forming Apparatus

Hereinafter, a basic image forming operation performed by the image forming apparatus 1 will be described.

Herein, an image forming operation in a case of forming a full-color image composed of a combination of toner images of four colors (Y, M, C, K) by using the four image creating devices 10 (Y, M, C, K) will be described. Note that, basically, the same applies to an image forming operation in a case of forming a single-color image or an image composed of a combination of toner images of a plurality of colors by using any one or more of the four image creating devices 10 (Y, M, C, K).

In a case where command information for a request for printing is received by the image forming apparatus 1, the control device 100 performs control such that the four image creating devices 10 (Y, M, C, K), the intermediate transfer device 20, the secondary transfer device 30, the fixing device 40, and the like are started.

Then, in each of the image creating devices 10 (Y, M, C, K), the photoconductor drum 11 rotates in a direction along the arrow A. The surface of each photoconductor drum 11 is charged to a required polarity (a negative polarity in Exemplary Embodiment 1) and a potential by each charging device 12. Next, the exposure device 13 irradiates the surface of the charged photoconductor drum 11 with light emitted based on an image signal which is obtained by converting image information input to the image forming apparatus 1 into each color component (Y, M, C, K). Then, an electrostatic latent image of each color component configured with a required potential difference is formed on the surface of the photoconductor drum 11.

Next, each of the development devices 14 (Y, M, C, K) supplies toner of a corresponding color (Y, M, C, K) charged to a required polarity (a negative polarity) to the electrostatic latent image of each color component formed on the photoconductor drum 11 and causes the toner to electrostatically adhere to the electrostatic latent image for development. Through such development, the electrostatic latent images of the respective color components formed on the respective photoconductor drums 11 are visualized as toner images of four colors (Y, M, C, K) developed with the toners of the corresponding colors.

Next, the toner images of the respective colors which are formed on the photoconductor drums 11 of the image creating devices 10 (Y, M, C, K) are transported to the primary transfer positions. Then, the primary transfer devices 15 primarily transfer the toner images of the respective colors onto the intermediate transfer belt 21 of the intermediate transfer device 20 to be superimposed sequentially, the intermediate transfer belt 21 rotating in a direction along the arrow B.

In addition, in each of the image creating devices 10 (Y, M, C, K) in which the primary transfer is finished, the drum cleaning device 16 removes an adhering substance by scraping off the adhering substance and cleans the surface of the photoconductor drum 11. Accordingly, each of the image creating devices 10 (Y, M, C, K) enters a state where the next image creating operation can be performed.

Next, the intermediate transfer device 20 holds the primarily transferred toner images and transports the toner images to the secondary transfer position by means of rotation of the intermediate transfer belt 21. Meanwhile, in the paper feeding device 50, the required recording sheet 5 is sent to the paper feed transport path 56 in accordance with an image creating operation. In the paper feed transport path 56, the sheet transporting roll pair 54 serving as a registration roll sends and supplies the recording sheet 5 to the secondary transfer position in accordance with the timing of transfer.

At the secondary transfer position, the secondary transfer roll 31 collectively secondarily transfers toner images on the intermediate transfer belt 21 to the recording sheet 5.

In addition, in the intermediate transfer device 20 after the end of the secondary transfer, the belt cleaning device 27 performs cleaning by removing an adhering substance such as toner remaining on the surface of the intermediate transfer belt 21 after the secondary transfer.

Next, the recording sheet 5 to which the toner images are secondarily transferred is transported to the fixing device 40 along the transport guide members 57 and 58 after being peeled off the intermediate transfer belt 21 and the secondary transfer roll 31. The fixing device 40 introduces the recording sheet 5 after the secondary transfer on which unfixed toner images are held to the fixation nip portion N between the heating roll 41 and the pressing roll 42 while the heating roll 41 and the pressing roll 42 are rotating and the fixing device 40 causes the recording sheet 5 to pass through the fixation nip portion N. In this manner, the fixing device 40 performs a necessary fixation process (heating and pressing) so that the unfixed toner images are fixed to the recording sheet 5. The recording sheet 5 after the end of fixation is discharged, by the sheet discharging roll pair 61, to the sheet discharge portion 60 via the transport guide member 59, the sheet discharge portion 60 being provided at the upper portion of the apparatus body 1a.

Through the above-described operation, a full-color image formed by a combination of toner images consisting of toner T (Y, M, C, K) of four colors is output.

### Configuration of Fixing Device

FIG. 5 is a cross-sectional configuration diagram showing the fixing device according to Exemplary Embodiment 1.

As shown in FIG. 5, the fixing device 40 includes the heating roll 41 which is an example of the heating rotary body and the pressing roll 42 which is an example of a pressing unit that presses the recording sheet 5 against the heating roll 41 at the fixation nip portion N which is an example of a fixation region.

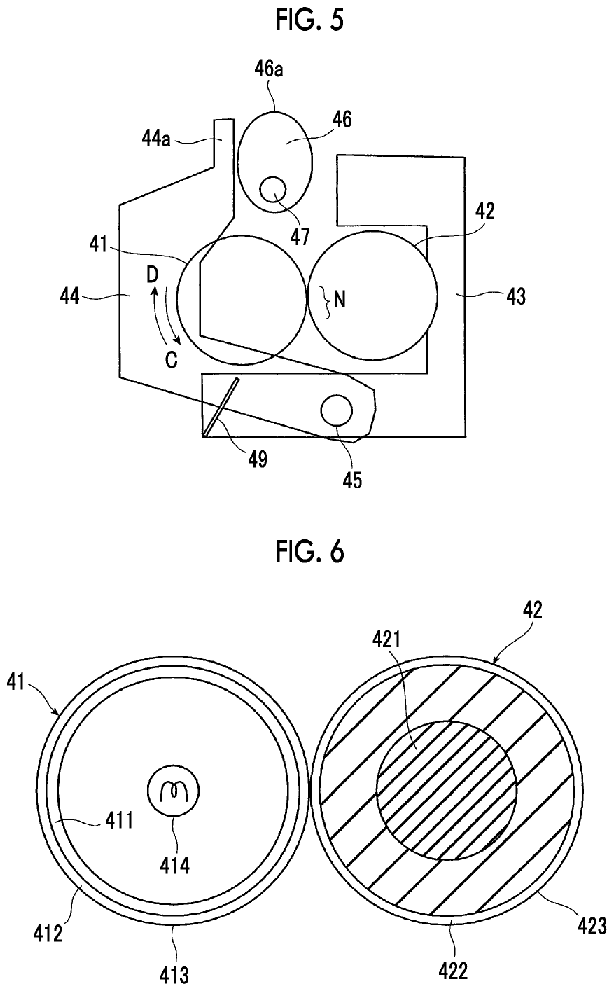

As shown in FIG. 6, the heating roll 41 includes a core metal 411 having a cylindrical shape, an elastic body layer 412, and a release layer 413. The core metal 411 consists of metal such as stainless steel, aluminum, or iron (a thin high-tension steel pipe). The core metal 411 is formed in a relatively thin cylindrical shape, and has a thermal capacity set to be considerably small. The elastic body layer 412 consists of a heat-resistant elastic body such as silicone rubber or fluororubber with which an outer periphery of the core metal 411 is coated. The elastic body layer 412 is also formed in a relatively thin cylindrical shape and contributes to a decrease in thermal capacity of the heating roll 41. The release layer 413 consists of polytetrafluoroethylene (PTFE), perfluoroalkoxyalkane (PFA), or the like, with which a surface of the elastic body layer 412 is thinly coated. A halogen lamp 414 which is an example of a heating unit is disposed in the heating roll 41.

Both end portions of the heating roll 41 in a longitudinal direction (an axial direction) thereof are rotatably supported by swinging arms 44 via a bearing member (not shown). The heating roll 41 is rotationally driven at a required speed in a direction along an arrow C by a drive motor, which is an example of a backward rotation unit (not shown) on the apparatus body 1a side, via a drive gear (not shown) that is attached to one end portion of the heating roll 41 in the axial direction. The drive motor is an example of a drive source. The heating roll 41 is configured such that the heating roll 41 can be rotated in the direction along the arrow C and a direction along an arrow D, which is a direction opposite to the direction along the arrow C, by the drive motor (not shown) even in a state of not being in pressure contact with the pressing roll 42. The pressing roll 42 is driven to rotate as the pressing roll 42 comes into pressure-contact with the rotationally driven heating roll 41 at the fixation nip portion N. In addition, it is a matter of course that the pressing roll 42 does not need to rotate by being driven by the heating roll 41 and a configuration in which the pressing roll 42 is rotationally driven may also be adopted.

A configuration in which the rotation speed of the heating roll 41, that is, the speed of fixation can be set to one of a plurality of speeds such as a high speed, a medium speed, and a low speed in accordance with the basis weight and the material of the recording sheet 5 may also be adopted.

The surface temperature of the heating roll 41 is detected by a temperature sensor (not shown). Energization of the halogen lamp 414 of the heating roll 41 is controlled, based on the result of detection performed by the temperature sensor, by a temperature control circuit in which a triac or the like (not shown) is used. As a result, a surface of the heating roll 41 is heated to a required fixation temperature.

Meanwhile, as shown in FIG. 6, the pressing roll 42 includes a core metal 421 having a columnar or cylindrical shape, an elastic body layer 422 formed to be relatively thick, and a release layer 423. The core metal 421 consists of metal such as stainless steel or iron. The core metal 421 is formed in a columnar shape of which the outer diameter is relatively large and has a rigidity set to be high. The elastic body layer 422 consists of a heat-resistant elastic body such as silicone rubber or fluororubber with which an outer periphery of the core metal 421 is coated relatively thickly. The release layer 423 consists of polytetrafluoroethylene (PTFE), perfluoroalkoxyalkane (PFA), or the like, with which a surface of the elastic body layer 422 is thinly coated.

Note that the pressing unit is not limited to a pressing unit consisting of a pressing roll and it is a matter of course that a pressing unit including a pressing belt or the like consisting of an endless belt may also be adopted.

As shown in FIG. 5, the fixing device 40 includes device frames 43 each of which is an example of a housing. The device frames 43 are disposed inside an exterior cover (not shown) of the fixing device 40. Both end portions of the pressing roll 42 in an axial direction are rotatably supported by the device frames 43. In addition, the swinging arms 44 are attached to the device frames 43 such that the swinging arms 44 can rotate about a fulcrum 45. The heating roll 41 is rotatably supported by the swinging arms 44. Tip end portions 44a of the swinging arms 44 are urged toward the pressing roll 42 side by an elastic member such as a coil spring (not shown). As a result, the heating roll 41 is in pressure-contact with a surface of the pressing roll 42 with a required pressing force at the time of fixation.

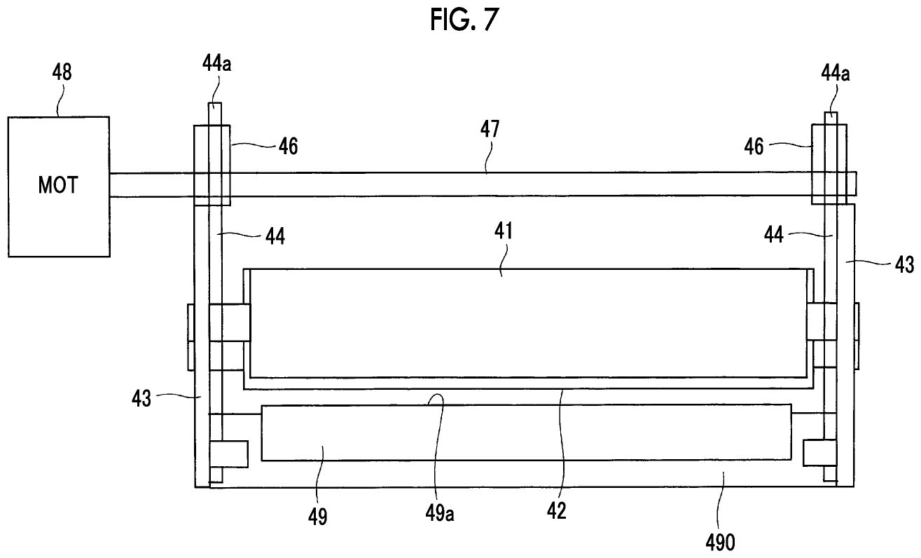

As shown in FIGS. 5 and 7, eccentric cams 46 abut the tip end portions 44a of the swinging arms 44. The eccentric cams 46 are respectively attached to both end portions of a drive shaft 47 in axial direction in a state of being fixed. The eccentric cams 46 are rotationally driven by a required rotation amount by a drive motor 48, which is an example of a drive unit, via the drive shaft 47.

At the time of fixation, the eccentric cams 46 are rotated to positions at which eccentric portions 46a are separated from the tip end portions 44a of the swinging arms 44 as shown in FIG. 5. Therefore, the heating roll 41 attached to the swinging arms 44 is brought into pressure-contact with the surface of the pressing roll 42 with a required pressing force by an urging force of an elastic member such as a coil spring (not shown).

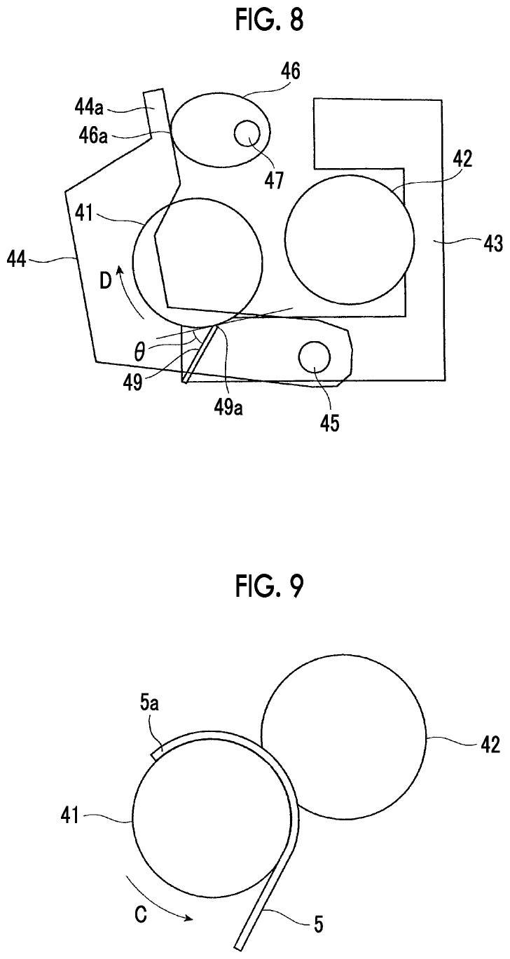

Meanwhile, at a time when fixation is not performed, the eccentric cams 46 are rotated to positions at which the eccentric portions 46a abut the tip end portions 44a of the swinging arms 44 as shown in FIG. 8. Therefore, the heating roll 41 rotatably attached to the swinging arms 44 is moved to a withdrawal position separated from the surface of the pressing roll 42 against the urging force of the elastic member such as the coil spring (not shown).

In the exemplary embodiment shown in the drawing, a state where the heating roll 41 is completely separated from the surface of the pressing roll 42 at a time when fixation is not performed has been described. However, the heating roll 41 does not need to be completely separated from the surface of the pressing roll 42 at a time when fixation is not performed and the heating roll 41 may be brought into contact with the pressing roll 42 in a state where a pressure-contact force with respect to the pressing roll 42 is lower than a pressure-contact force at the time of normal fixation.

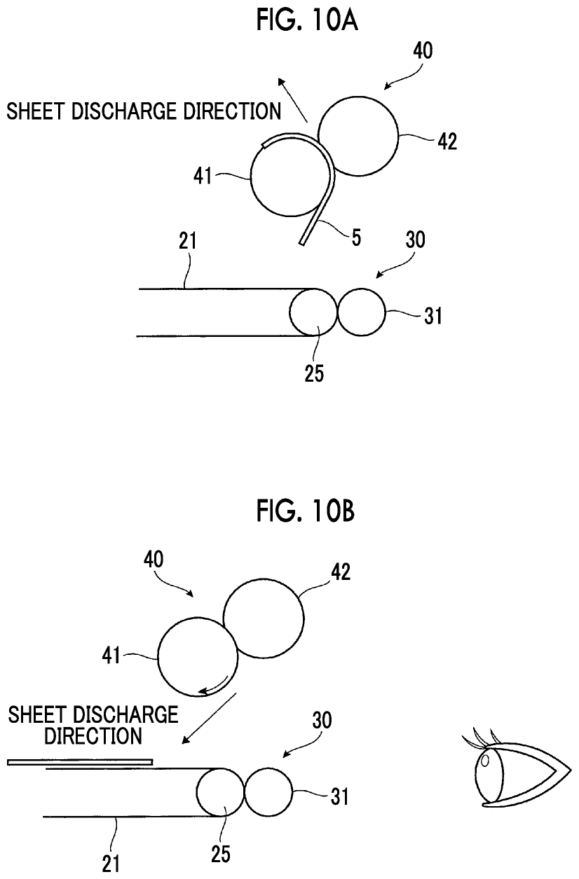

Meanwhile, in the fixing device 40 configured as described above, the fixation process may be performed with respect to the small-size recording sheet 5 of which the length in the transport direction of the recording sheet 5 is relatively small like B6 size paper (128×182 mm), A6 size paper (105×148 mm), A5 size paper (148×210 mm), and the like. The length of the small-size recording sheet 5 in the transport direction is small in comparison with other recording sheets 5 of a A4 size or the like. Therefore, particularly in the case of long edge feed (LEF) or the like in which the recording sheet 5 is transported such that a long side of the recording sheet 5 is positioned as a leading end in the transport direction, the recording sheet 5 may be bent into a shape resembling an outer periphery of the heating roll 41 due to the pressure-contact force of the pressing roll 42 and may be wound around the outer periphery of the heating roll 41 as shown in FIG. 9, which causes a transport failure (a jam). In a case where a transport failure (a jam) in which the small-size recording sheet 5 is wound around the outer periphery of the heating roll 41 occurs as described above, it is difficult for a user to visually recognize the transport failure as shown in FIG. 10A because the length of the recording sheet 5 in the transport direction is small.

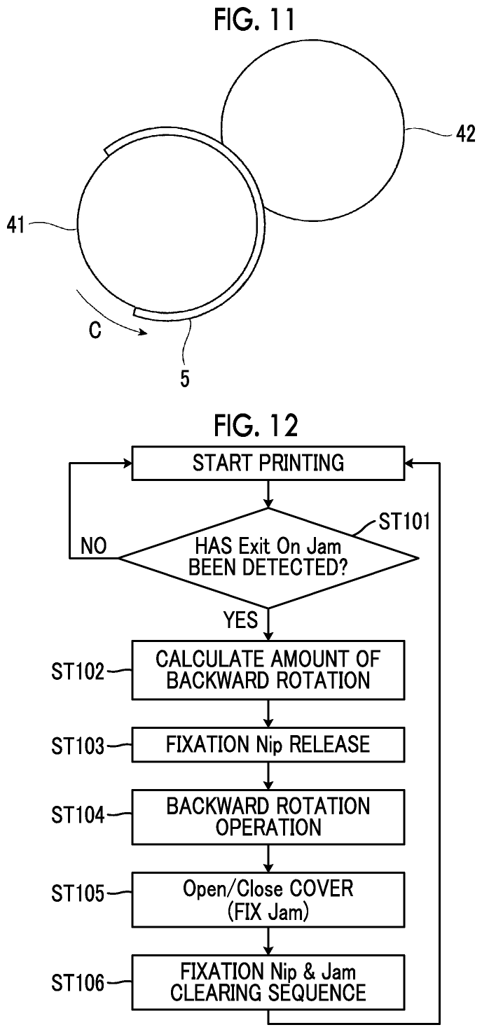

Therefore, in a case where a transport failure (a jam) caused by the recording sheet 5 wound around the outer periphery of the heating roll 41 is detected in the fixing device 40 of the related art, the recording sheet 5 wound around the outer periphery may not be found in a state where the rear cover 80 of the apparatus body 1a is open as shown in FIG. 4 and the next printing operation may be started in a state where the recording sheet 5 wound around the outer periphery of the heating roll 41 is not removed. In this case, as shown in FIG. 11, there is a technical problem that the recording sheet 5 is completely wound around the outer periphery of the heating roll 41, the recording sheet 5 cannot be removed from the heating roll 41, and a failure in which the image forming apparatus 1 itself including the fixing device 40 becomes unusable occurs.

Therefore, regarding the fixing device, techniques of removing the recording sheet 5 by causing the heating roll 41 to rotate in a direction opposite to the direction of rotation at the time of fixation in a case where the recording sheet 5 is wound around the outer periphery of the heating roll 41 have been proposed (JP2014-174542A, JP2005-309022A, and the like).

However, even in the case of such techniques, there is still a technical problem that it is difficult to visually recognize the recording sheet 5 wound around the outer periphery of the heating roll 41 or to peel off the recording sheet 5 wound around the outer periphery of the heating roll 41 although depending on the basis weight of the recording sheet 5.

In addition, in a case where the heating roll 41 is caused to rotate in the direction opposite to the direction of rotation at the time of fixation, although depending on the amount of backward rotation of the heating roll 41, there is a technical problem that the recording sheet 5 peeled off the heating roll 41 enters the inside of the apparatus body 1a of the image forming apparatus 1 along the intermediate transfer belt 21 as shown in FIG. 10B and thus it becomes difficult to visually recognize the recording sheet 5 from outside.

Therefore, the fixing device according to Exemplary Embodiment 1 is configured to include a peeling unit that is brought relatively close to an outer peripheral surface of a heating rotary body at a position upstream of a fixation region in a transport direction of a recording medium and that peels off the recording medium wound around the heating rotary body at the time of backward rotation of the heating rotary body.

That is, as shown in FIG. 5, the fixing device 40 of Exemplary Embodiment 1 is configured such that a state where the heating roll 41 and the pressing roll 42 are in pressure contact with each other ends and the heating roll 41 is caused to rotate in an opposite direction D to the direction of rotation at the time of normal fixation.

As shown in FIGS. 7 and 8, the outer periphery of the heating roll 41 is provided with a peeling film 49, which is an example of a peeling unit that is brought relatively close to the outer peripheral surface of the heating roll 41 at a position upstream of the fixation nip portion N in the transport direction of the recording sheet 5 (that is, a position below the fixation nip portion N in FIG. 8) and that peels off the recording sheet 5 wound around the heating roll 41 when the heating roll 41 is moved to the withdrawal position and the heating roll 41 rotates backward. In the fixing device 40 according to Exemplary Embodiment 1, as shown in FIG. 8, the recording sheet 5 is transported from a lower side to an upper side in the vertical direction Z along the transport guide members 57 and 58 (refer to FIG. 1). An introduction port through which the recording sheet 5 is introduced is open at a lower side in the vertical direction Z of an exterior cover (not shown) of the fixing device 40. Therefore, it is desirable that, for example, the recording sheet 5 that is peeled off the surface of the heating roll 41 by the peeling film 49 in a case where the heating roll 41 is rotated backward is discharged through the introduction port for the recording sheet 5 as it is.

Therefore, in the fixing device 40 according to Exemplary Embodiment 1, as shown in FIG. 8, a tip end 49a of the peeling film 49 is provided to be positioned closer to the fixation nip portion N side than a lower end portion of the heating roll 41 is.

The peeling film 49 is composed of a mylar film or the like having a required thickness. As shown in FIG. 7, the peeling film 49 is attached in a state of being fixed to a supporting blade 490 suspended between the right and left device frame 43 by double-sided tape, an adhesive, or the like. The peeling film 49 is disposed in a non-contact state such that the tip end 49a thereof is brought close to the surface of the heating roll 41 with a minute gap interposed therebetween, for example. In addition, the peeling film 49 may also be disposed such that the tip end 49a is brought into contact with the surface of the heating roll 41 slightly.

With respect to the surface of the heating roll 41, the peeling film 49 is disposed as a so-called doctor blade in a state of being inclined at a required inclination angle θ with respect to a line tangent to the closest position on the heating roll 41 from a downstream side to an upstream side in a rotation direction D at the time of backward rotation. Note that it is effective to set the inclination angle θ to 45 degrees or less from the viewpoint of peeling off the recording sheet 5.

As shown in FIG. 8, at a time when fixation is not performed, the heating roll 41 is moved to a position at which the outer peripheral surface of the heating roll 41 faces the tip end 49a of the peeling film 49 with a minute gap interposed therebetween due to a withdrawal operation accompanied by rotation of the eccentric cams 46. The heating roll 41 is configured such that the heating roll 41 can be rotated in the opposite direction D to the direction of rotation at the time of fixation by an independent drive unit (not shown) even in a state where the heating roll 41 is separated from the pressing roll 42. It is desirable that a speed at which the heating roll 41 is rotated in the opposite direction D is set to be a speed lower than the speed of rotation at the time of normal fixation, for example.

The amount of backward rotation of the heating roll 41 in the opposite direction is obtained by Equation (1) as follows.

$$Amount of backward rotation = V ( {t}^{′} - t ) + a \qquad ( 1 )$$

Here, t is a pre-designed theoretical timing time between a time when the registration sensor 201 is turned on and a time when the exit sensor 204 of the fixing device 40 is turned on, t′ is an actual time (t′>t) between a time when the registration sensor 201 is turned on and a time when the image forming apparatus 1 (the fixing device 40) is actually stopped after a transport failure of the recording sheet 5 is detected by the exit sensor 204, V is the speed of transportation at the time of fixation on the recording sheet 5, and a is an optional value and is set to be equal to or greater than a distance by which a user can access the recording sheet 5 in the case of the recording sheet 5 having a minimum size. Note that a value to which the optional value a is set differs depending on the size of the recording sheet 5.

In a case where the recording sheet 5 is not wound around the outer periphery of the heating roll 41, the recording sheet 5 subjected to the fixation process by the heating roll 41 and the pressing roll 42 is peeled off the surface of the heating roll 41 due to the rigidity of the recording sheet 5 and passage of a leading end 5a is detected by the exit sensor 204 of the fixing device 40 which is disposed downstream of the fixation nip portion N.

Meanwhile, in a case where the recording sheet 5 is wound around the outer periphery of the heating roll 41, the recording sheet 5 subjected to the fixation process by the heating roll 41 and the pressing roll 42 is not peeled off the surface of the heating roll 41 as shown in FIG. 3, moves along with the surface of the heating roll 41. Then, the fixing device 40 is stopped and rotation of the heating roll 41 is also stopped at a time point when a transport failure of the recording sheet 5 is detected.

The theoretical timing time t is stored in advance in a storage unit of the control device. In addition, regarding the actual time t′, the control device may have a timer function to actually measure the length of a time between a time when the registration sensor is turned on and a time when the image forming apparatus 1 (the fixing device 40) is actually stopped after a transport failure of the recording sheet 5 is detected by the exit sensor and the actual time t′ may be a value that is set in advance in consideration of a certain margin.

In any case, since the optional value a is set in above-described Equation (1) for calculation of the amount of backward rotation of the heating roll 41, a value that is stored in advance in the storage unit of the control device may be used as the actual time t′.

In addition, in a case where the optional value a is excessively large in Equation (1) for calculation of the amount of backward rotation of the heating roll 41, as described above, the recording sheet 5 may enter the inside of the apparatus body 1a along the surface of the intermediate transfer belt 21 as shown in FIG. 10B. It is desirable that the optional value a is set to, for example, a value at which the trailing end of the recording sheet 5 of which a transport failure has occurred is positioned close to the secondary transfer device 30 and a user can easily visually recognize the trailing end in a case where a rear surface cover of the apparatus body 1a is opened.

Regarding the amount of backward rotation of the heating roll 41, the optional value a plays a major role since the value of V(t′−t) is not so large in Equation (1). The optional value a is set such that the trailing end of the recording sheet 5 in the transport direction is positioned outside the introduction port of the fixing device 40 and is positioned upstream of the secondary transfer position in the transport direction of the recording sheet 5 when a backward rotation operation of the heating roll 41 is finished.

### Action of Fixing Device

According to the above-described configuration, in the fixing device according to Exemplary Embodiment 1, it is possible to reliably remove, in a manner as follows, the recording medium wound around the outer peripheral surface of the heating rotary body in comparison with a case where the peeling unit that peels off the recording medium wound around the outer peripheral surface of the heating rotary body when the heating rotary body rotates backward is provided downstream of the fixation region in a transport direction of the recording medium.

That is, in the image forming apparatus 1 to which the fixing device 40 according to Exemplary Embodiment 1 is applied, as shown in FIG. 1, toner images of respective colors which are formed in the image creating devices 10 (Y, M, C, K) of yellow (Y), magenta (M), cyan (C), and black (K) are collectively secondarily transferred to the recording sheet 5 via the intermediate transfer belt 21. The toner images of the respective colors which are secondarily transferred to the recording sheet 5 are transported to the fixing device 40 and are fixed onto the recording sheet 5 by being heated and pressed.

In this case, as shown in FIG. 3, the leading end 5a of the recording sheet 5 in the transport direction of the recording sheet 5 is detected by the registration sensor 201 which is disposed upstream of the sheet transporting roll pair 54 in the transport direction. In addition, after the recording sheet 5 is transported to the fixing device 40 to be subjected to the fixation process and the recording sheet 5 is discharged from the fixing device 40, the leading end 5a of the recording sheet 5 is detected by the exit sensor 204 which is disposed downstream of the fixing device 40 in the transport direction of the recording sheet 5.

The control device 100 measures a time between a time when the leading end 5a of the recording sheet 5 is detected by the registration sensor 201 and a time when the leading end 5a is detected by the exit sensor 204 and in a case where the length of the measured time does not fall within a predetermined range, the control device 100 determines that a transport failure (a jam) of the recording sheet 5 has occurred and immediately stops the image forming apparatus 1.

In a case where the transport failure (the jam) of the recording sheet 5 is detected (step ST101), as shown in FIG. 12, the control device 100 calculates the amount of backward rotation of the heating roll 41 of the fixing device 40 based on Equation (1) (step ST102).

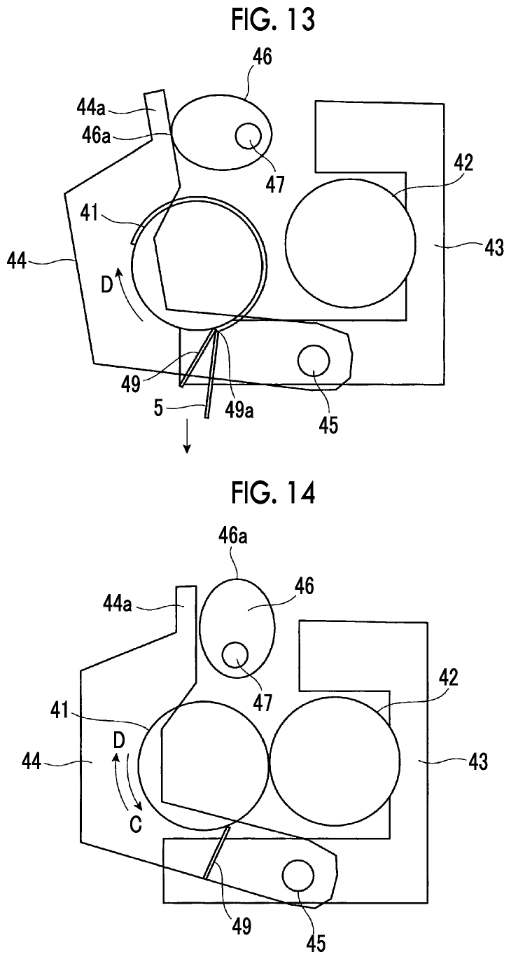

Thereafter, the control device 100 drives the drive motor 48 such that the heating roll 41 and the pressing roll 42 are separated from each other and a state where the heating roll 41 and the pressing roll 42 are in pressure-contact with each other at the fixation nip portion N ends (step ST103). That is, the fixing device 40 enters a state as shown in FIG. 13.

Next, the control device 100 executes a backward rotation operation of rotating, by the amount of backward rotation obtained based on Equation (1), the heating roll 41 in a direction opposite to the direction of rotation at the time of normal fixation (step ST104). Note that at this time, in the fixing device 40, the halogen lamp 414 of the heating roll 41 is energized, and thus the heating roll 41 is in a heated state. Since the heating roll 41 is heated at the time of backward rotation of the heating roll 41 in this manner, the recording sheet 5 may be prevented from being difficult to peel off the heating roll 41 due to solidification of a toner image on the recording sheet 5 in comparison with a case where heating is stopped before rotation in the direction opposite to the direction of rotation at the time of fixation is stopped.

Next, the control device 100 causes a display unit of a user interface (not shown) to display a message to cause a user to perform an operation of opening the rear cover 80 and thus the rear cover 80 of the image forming apparatus 1 is opened by the user (step ST105).

Then, the user opens the rear cover 80 of the image forming apparatus 1 as shown in FIG. 4 and manually removes the recording sheet 5 that has been peeled off the outer periphery of the heating roll 41 of the fixing device 40 and of which a trailing end is positioned between the fixing device 40 and the secondary transfer position, so that a process on the recording sheet 5 of which the transport failure has occurred is finished. Thereafter, the rear cover 80 of the image forming apparatus 1 is closed by the user. Note that whether the rear cover 80 is open or closed is detected by the control device 100.

Finally, the control device 100 drives the drive motor 48 to bring the heating roll 41 into pressure-contact with the pressing roll 42, performs a required jam clearing sequence (step ST106) including cleaning the photoconductor drums 11 of the image creating devices 10 (Y, M, C, K) of yellow (Y), magenta (M), cyan (C), and black (K) by means of the drum cleaning devices 16 and cleaning the intermediate transfer belt 21 of the intermediate transfer device 20 by means of the belt cleaning device 27, and starts a printing operation again.

As described above, in the fixing device 40 according to Exemplary Embodiment 1, the recording sheet 5 may be reliably peeled off the surface of the heating roll 41 by the peeling film 49 when the recording sheet 5 is wound around the outer periphery of the heating roll 41, the peeling film 49 being disposed upstream of the fixation nip portion N. A state where the recording sheet 5 is peeled off the surface of the heating roll 41 by the peeling film 49 is as shown in FIG. 13.

In addition, in the fixing device 40 according to Exemplary Embodiment 1, since the amount of backward rotation of the heating roll 41 is set to a value calculated based on predetermined Equation (1), it is possible to reliably prevent the amount of backward rotation of heating roll 41 from being excessive and to prevent the recording sheet 5 peeled off the surface of the heating roll 41 from entering the inside of the apparatus body 1a along the surface of the intermediate transfer belt 21.

### Exemplary Embodiment 2

FIG. 14 shows a fixing device according to Exemplary Embodiment 2 of the present invention. The fixing device according to Exemplary embodiment 2 is configured such that the heating rotary body is rotated backward and stopped based on the result of detection performed by the detection unit such that a leading end of a recording medium is positioned at the fixation region.

In addition, in the fixing device according to Exemplary embodiment 2, the heating rotary body is configured such that a state where the heating rotary body and the pressing unit press each other ends after the heating rotary body is rotated in a direction opposite to the direction of rotation at the time of fixation by a backward rotation unit. However, the heating rotary body may be configured such that the state where the heating rotary body and the pressing unit press each other ends before the heating rotary body is rotated in the direction opposite to the direction of rotation at the time of fixation by the backward rotation unit.

That is, the fixing device 40 according to Exemplary Embodiment 2 of the present invention is configured such that the peeling film 49 is provided at the swinging arms 44 as shown in FIG. 14 instead of being provided at the device frames 43. A tip end of the peeling film 49 provided at the swinging arms 44 is disposed to face the surface of the heating roll 41 and to be close to the surface with a minute gap interposed therebetween in a state where the heating roll 41 is in pressure-contact with the pressing roll 42. Note that the peeling film 49 may also be disposed such that the tip end of the peeling film 49 is brought into contact with the surface of the heating roll 41 slightly with substantially no gap therebetween.

In addition, in the fixing device 40 according to Exemplary Embodiment 2 of the present invention, as with Exemplary Embodiment 1 described above, the amount of backward rotation of the heating roll 41 is calculated based on Equation (1) as follows in a case where the heating roll 41 is to be rotated backward.

$$Amount of backward rotation = V ( {t}^{′} - t ) + a \qquad ( 1 )$$

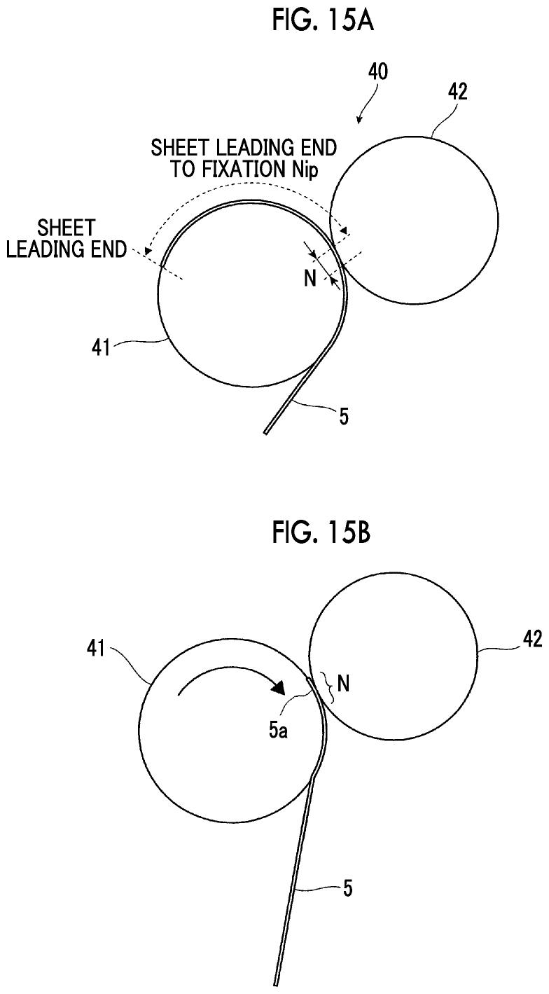

However, in the fixing device 40 according to Exemplary Embodiment 2 of the present invention, the optional value a in Equation (1) is set such that the heating roll 41 is rotated backward and stopped with the leading end 5a of the recording sheet 5 positioned at the fixation nip portion N as shown in FIGS. 15A and 15B.

In a case where the recording sheet 5 is wound around the surface of the heating roll 41, as shown in FIG. 3, the optional value a is set based on the time t at which the leading end of the recording sheet 5 is supposed to be detected by the exit sensor 204 in a normal case where the recording sheet 5 is not wound around the surface of the heating roll 41.

Regarding Equation (1), the amount of backward rotation of the heating roll 41 is calculated in consideration of a difference between the time t at which the leading end of the recording sheet 5 is theoretically supposed to be detected by the exit sensor 204 and the time t′ at which the fixing device 40 is actually stopped since the leading end of the recording sheet 5 is not actually detected by the exit sensor 204 and a jam is detected.

Therefore, in a case where the optional value a of Equation (1) is set to a length equal to the length of a transport path of the recording sheet 5 from the fixation nip portion N of the fixing device 40 to the exit sensor 204, the leading end 5a of the recording sheet 5 can be stopped to be positioned at the fixation nip portion N, in which the heating roll 41 and the pressing roll 42 come into pressure-contact with each other, when the heating roll 41 is rotated backward.

Note that there is an error of about ±2 mm in position accuracy of the leading end 5a of the recording sheet 5 at the time of transportation of the recording sheet 5. Meanwhile, the fixation nip portion N of the fixing device 40 usually has a length of 4 mm or more.

Therefore, in the fixing device 40 according to Exemplary Embodiment 2 of the present invention, since the amount of backward rotation of the heating roll 41 is calculated based on Equation (1) described above, it is actually possible to stop the leading end 5a of the recording sheet 5 at the position of the fixation nip portion N at the time of backward rotation of the heating roll 41.

According to the above-described configuration, in the fixing device according to Exemplary Embodiment 2, it is possible to reliably remove, in a manner as follows, the recording medium wound around the outer peripheral surface of the heating rotary body in comparison with a case where the peeling unit that peels off the recording medium wound around the outer peripheral surface of the heating rotary body when the heating rotary body rotates backward is provided downstream of the fixation region in a transport direction of the recording medium.

That is, in the image forming apparatus 1 to which the fixing device 40 according to Exemplary Embodiment 2 is applied, as shown in FIG. 1, toner images of respective colors which are formed in the image creating devices 10 (Y, M, C, K) of yellow (Y), magenta (M), cyan (C), and black (K) are collectively secondarily transferred to the recording sheet 5 via the intermediate transfer belt 21. The toner images of the respective colors which are secondarily transferred to the recording sheet 5 are transported to the fixing device 40 and are fixed onto the recording sheet 5 by being heated and pressed.

In this case, as shown in FIG. 3, the leading end 5a of the recording sheet 5 in the transport direction of the recording sheet 5 is detected by the registration sensor 201 which is disposed upstream of the sheet transporting roll pair 54 in the transport direction. In addition, after the recording sheet 5 is transported to the fixing device 40 to be subjected to the fixation process and the recording sheet 5 is discharged from the fixing device 40, the leading end 5a of the recording sheet 5 is detected by the exit sensor 204 which is disposed downstream of the fixing device 40 in the transport direction of the recording sheet 5.

The control device 100 measures a time between a time when the leading end 5a of the recording sheet 5 is detected by the registration sensor 201 and a time when the leading end 5a is detected by the exit sensor 204 and in a case where the length of the measured time does not fall within a predetermined range, the control device 100 determines that a transport failure (a jam) of the recording sheet 5 has occurred and immediately stops the image forming apparatus 1.

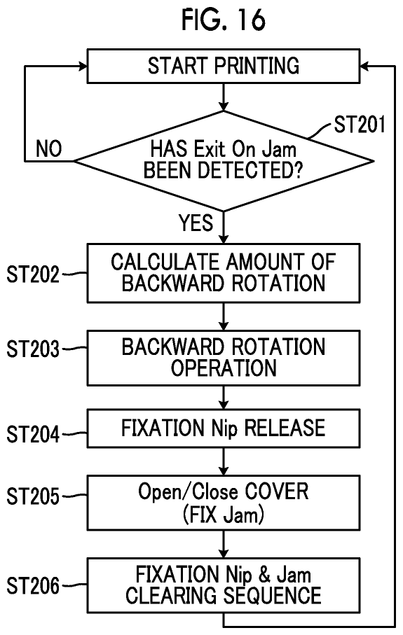

In a case where the transport failure (the jam) of the recording sheet 5 is detected (step ST201), as shown in FIG. 16, the control device 100 calculates the amount of backward rotation of the heating roll 41 of the fixing device 40 based on Equation (1) (step ST202).

However, here, the amount of backward rotation of the heating roll 41 which is calculated based on Equation (1) is set such that the leading end 5a of the recording sheet 5 is stopped at the position of the fixation nip portion N of the fixing device 40 as shown in FIG. 15B unlike Exemplary Embodiment 1.

Thereafter, the control device 100 executes a backward rotation operation of rotating, by the amount of backward rotation obtained based on Equation (1), the heating roll 41 in a direction opposite to the direction of rotation at the time of normal fixation (step ST203). Note that at this time, in the fixing device 40, the halogen lamp 414 of the heating roll 41 is energized, and thus the heating roll 41 is in a heated state.

Next, the control device 100 drives the drive motor 48 such that the heating roll 41 and the pressing roll 42 are separated from each other and a state where the heating roll 41 and the pressing roll 42 are in pressure-contact with each other at the fixation nip portion N ends (step ST204).

Thereafter, the control device 100 causes a display unit of a user interface (not shown) to display a message to cause a user to perform an operation of opening the rear cover 80 and thus the rear cover 80 of the image forming apparatus 1 is opened by the user (step ST205).

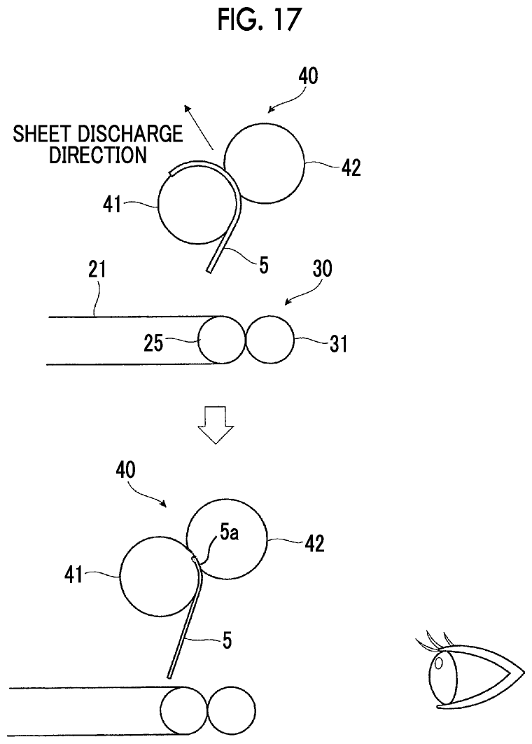

Then, the user opens the rear cover 80 of the image forming apparatus 1 as shown in FIG. 4 and manually removes the recording sheet 5 that has been peeled off the outer periphery of the heating roll 41 of the fixing device 40 and of which a trailing end is positioned between the fixing device 40 and the secondary transfer position as shown in FIG. 17, so that a process on the recording sheet 5 of which the transport failure has occurred is finished. Thereafter, the rear cover 80 of the image forming apparatus 1 is closed by the user.

Finally, the control device 100 drives the drive motor 48 to bring the heating roll 41 into pressure-contact with the pressing roll 42, performs a required jam clearing sequence (step ST206) including cleaning the photoconductor drums 11 of the image creating devices 10 (Y, M, C, K) of yellow (Y), magenta (M), cyan (C), and black (K) by means of the drum cleaning devices 16 and cleaning the intermediate transfer belt 21 of the intermediate transfer device 20 by means of the belt cleaning device 27, and starts a printing operation again.

Since the backward rotation operation of rotating the heating roll 41 in the direction opposite to the direction of rotation at the time of normal fixation by the amount of backward rotation obtained based on Equation (1) is performed as described above, the leading end 5a of the recording sheet 5 wound around the surface of the heating roll 41 is stopped in a state of being positioned at the fixation nip portion N as shown in FIG. 15B.

Therefore, in Exemplary Embodiment 2, it is possible to easily remove the recording sheet 5 of which the leading end 5a is stopped at the fixation nip portion N of the fixing device 40 as shown in FIG. 17 by pulling the recording sheet 5.

In addition, in Exemplary Embodiment 2, it is possible to reliably prevent the amount of backward rotation of heating roll 41 from being excessive and to prevent the recording sheet 5 from entering the inside of the apparatus body 1a along the surface of the intermediate transfer belt 21 at the time of backward rotation of the heating roll 41.

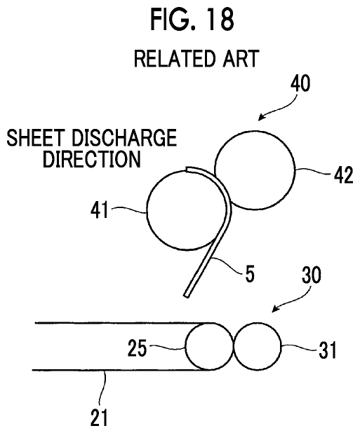

Furthermore, there is no case where the amount of backward rotation of the heating roll 41 becomes insufficient at the time of backward rotation of the heating roll 41 as shown in FIG. 18 and thus a great force rotating the heating roll 41 and the pressing roll 42 that are in pressure-contact with each other is not needed in the case of removal of the recording sheet 5.

Since other components and operations are similar to the components and operations in the exemplary embodiments described above, description thereof will be omitted.

Although a full-color image forming apparatus has been described as an image forming apparatus in the exemplary embodiments, it is a matter of course that the same applies to a monochrome image forming apparatus.

### Supplementary Note

(((1)))

A fixing device comprising:
a heating rotary body;
a pressing unit that presses a recording medium against the heating rotary body at a fixation region;
a backward rotation unit that rotates the heating rotary body in a direction opposite to a direction of rotation at a time of fixation in a case where the recording medium is wound around the heating rotary body; and
a peeling unit that is brought relatively close to an outer peripheral surface of the heating rotary body at a position upstream of the fixation region in a transport direction of the recording medium and that peels off the recording medium wound around the heating rotary body at a time of backward rotation of the heating rotary body.

(((2)))

The fixing device according to (((1))), further comprising:
a detection unit that is provided downstream of the fixation region in the transport direction of the recording medium and that detects passage of the recording medium.

(((3)))

The fixing device according to (((2))),
wherein an amount by which the recording medium is wound around the heating rotary body is specified based on a result of detection performed by the detection unit.

(((4)))

The fixing device according to (((1))),
wherein the peeling unit is brought relatively close to the outer peripheral surface of the heating rotary body in a case where the heating rotary body is moved.

(5)

The fixing device according to (((2))),
wherein the heating rotary body is rotated backward and stopped based on a result of detection performed by the detection unit such that a leading end of the recording medium is positioned at the fixation region.

(6)

The fixing device according to (((5))),
wherein a state where the heating rotary body and the pressing unit press each other ends before the heating rotary body is rotated in the direction opposite to the direction of rotation at the time of fixation by the backward rotation unit.

(((7))

The fixing device according to (((5)),
wherein a state where the heating rotary body and the pressing unit press each other ends after the heating rotary body is rotated in the direction opposite to the direction of rotation at the time of fixation by the backward rotation unit.

(((8)))

The fixing device according to (((5))),
wherein heating of the heating rotary body is stopped after the heating rotary body stops to be rotated in the direction opposite to the direction of rotation at the time of fixation.

(((9)))

An image forming apparatus comprising:
an image forming section that forms an image on a recording medium; and
a fixing section that fixes the image on the recording medium,
wherein the fixing device according to any one of (((1))) to (((8))) is used as the fixing section.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising:
a heating rotary body;
a pressing unit that presses a recording medium against the heating rotary body at a fixation region;
a backward rotation unit that rotates the heating rotary body in a direction opposite to a direction of rotation at a time of fixation in a case where the recording medium is wound around the heating rotary body; and
a peeling unit that is brought relatively close to an outer peripheral surface of the heating rotary body at a position upstream of the fixation region in a transport direction of the recording medium and that peels off the recording medium wound around the heating rotary body at a time of backward rotation of the heating rotary body.

2. The fixing device according to claim 1, further comprising:
a detection unit that is provided downstream of the fixation region in the transport direction of the recording medium and that detects passage of the recording medium.

3. The fixing device according to claim 2,
wherein an amount by which the recording medium is wound around the heating rotary body is specified based on a result of detection performed by the detection unit.

4. The fixing device according to claim 1,
wherein the peeling unit is brought relatively close to the outer peripheral surface of the heating rotary body in a case where the heating rotary body is moved.

5. The fixing device according to claim 2,
wherein the heating rotary body is rotated backward and stopped based on a result of detection performed by the detection unit such that a leading end of the recording medium is positioned at the fixation region.

6. The fixing device according to claim 5,
wherein a state where the heating rotary body and the pressing unit press each other ends before the heating rotary body is rotated in the direction opposite to the direction of rotation at the time of fixation by the backward rotation unit.

7. The fixing device according to claim 5,
wherein a state where the heating rotary body and the pressing unit press each other ends after the heating rotary body is rotated in the direction opposite to the direction of rotation at the time of fixation by the backward rotation unit.

8. The fixing device according to claim 5,
wherein heating of the heating rotary body is stopped after the heating rotary body stops to be rotated in the direction opposite to the direction of rotation at the time of fixation.

9. An image forming apparatus comprising:
an image forming section that forms an image on a recording medium; and
a fixing section that fixes the image on the recording medium,
wherein the fixing device according to claim 1 is used as the fixing section.

10. An image forming apparatus comprising:
an image forming section that forms an image on a recording medium; and
a fixing section that fixes the image on the recording medium,
wherein the fixing device according to claim 2 is used as the fixing section.

11. An image forming apparatus comprising:
an image forming section that forms an image on a recording medium; and
a fixing section that fixes the image on the recording medium,
wherein the fixing device according to claim 3 is used as the fixing section.

12. An image forming apparatus comprising:
an image forming section that forms an image on a recording medium; and
a fixing section that fixes the image on the recording medium,
wherein the fixing device according to claim 4 is used as the fixing section.

13. An image forming apparatus comprising:
an image forming section that forms an image on a recording medium; and
a fixing section that fixes the image on the recording medium,
wherein the fixing device according to claim 5 is used as the fixing section.

14. An image forming apparatus comprising:
an image forming section that forms an image on a recording medium; and
a fixing section that fixes the image on the recording medium,
wherein the fixing device according to claim 6 is used as the fixing section.

15. An image forming apparatus comprising:
an image forming section that forms an image on a recording medium; and
a fixing section that fixes the image on the recording medium,
wherein the fixing device according to claim 7 is used as the fixing section.

16. An image forming apparatus comprising:
an image forming section that forms an image on a recording medium; and
a fixing section that fixes the image on the recording medium,
wherein the fixing device according to claim 8 is used as the fixing section.

17. A fixing device comprising:
a heating rotary body;
pressing means for pressing a recording medium against the heating rotary body at a fixation region;
backward rotation means for rotating the heating rotary body in a direction opposite to a direction of rotation at a time of fixation in a case where the recording medium is wound around the heating rotary body; and
peeling means for peeling off the recording medium wound around the heating rotary body at a time of backward rotation of the heating rotary body, the peeling means being brought relatively close to an outer peripheral surface of the heating rotary body at a position upstream of the fixation region in a transport direction of the recording medium.
